(19) United States
(12) Patent Application Publication
(10) Pub. No.: US 2024/0369186 A1
(43) Pub. Date: Nov. 7, 2024

(54) TANK DEVICE FOR STORING A GASEOUS MEDIUM

(71) Applicant: Robert Bosch GmbH, Stuttgart (DE)

(72) Inventors: Friedrich Muehleder, Muehlacker (DE); Jochen Wessner, Esslingen (DE); Matthias Kuntz, Stuttgart (DE); Udo Schaich, Stuttgart (DE)

(21) Appl. No.: 18/576,174

(22) PCT Filed: Jun. 1, 2022
(86) PCT No.: PCT/EP2022/064864

§ 371 Date: Jan. 3, 2024

(30) Foreign Application Priority Data
Jul. 8, 2021 (DE) 10 2021 207 187.2

(51) Int. Cl. F17C 1/02; F17C 1/12; F17C 13/04; F17C 13/08

(52) U.S. Cl. CPC F17C 1/02; F17C 1/12; F17C 13/045; F17C 13/084; F17C 2221/012; F17C 2265/06

(57) ABSTRACT

Tank device (1) for storing a gaseous medium, in particular hydrogen, comprising at least one tank container (2) and a feed line (4) which can be connected to the at least one tank container (2), said at least one tank container (2) being fluidically connected to the feed line (4) by means of at least one valve (8, 10). The at least one tank container (2) is fluidically connected to a connection line (11) via at least one valve (8, 10), wherein a frame-shaped housing element (24) is arranged in the tank device (1), said housing element (24) surrounding the at least one tank container (2) and the feed line (4). The housing element (24) can additionally be thermally activated.

### BACKGROUND

The invention relates to a tank device for storing a gaseous medium, in particular hydrogen, for example for the hydrogen supply in a fuel cell system or in a hydrogen burner system. The invention is used, for example, in vehicles with a fuel cell drive or vehicles with a hydrogen burner as a drive.

DE 10 2017 212 485 A1 describes a device for storing compressed fluids that serve as fuel for a vehicle, the device comprising at least two tubular tank modules and at least one high-pressure fuel distributor having at least one integrated control and safety system. In addition, the at least two tubular tank modules are made of metal and are modularly connected to the at least one high-pressure fuel allotment with the at least one integrated control and safety technology to form a module in flexible geometry.

A variety of valves are required for these safety precautions, thereby increasing the complexity of the overall gas storage system and its cost. Furthermore, depending on the position of the safety valve, it must be ensured that it is also triggered when the source of fire is not in proximity to the safety valve in order to prevent a possible explosion of the gas storage system.

However, if one or more tank containers are damaged, the compressed fluid, for example hydrogen, may escape or the tank container may even burst.

### SUMMARY

In contrast, the tank device according to the invention has the advantage that the high safety requirements, in particular with regard to handling hydrogen, are met at all times and bursting of the tank device is prevented.

To this end, the tank device for storing hydrogen comprises at least one tank container and a feed line which can be connected to the at least one tank container. The at least one tank container is fluidically connected to the feed line by means of at least one valve, said at least one tank container being fluidically connected to a connection line via at least one valve. A frame-shaped housing element is arranged in the tank device, said housing element surrounding the at least one tank container and the feed line. The housing element can additionally be thermally activated.

Thus, it can be easily ensured that even if the tank device or tank container is damaged or if gas, in this case hydrogen, escapes from the tank containers, the possibility of the tank device catching fire or even bursting is prevented.

In the first advantageous further development, it is provided that the housing element comprises an underbody, said underbody comprising at least one steel sheet. Advantageously, the underbody has a fire-retardant coating. The fire-retardant coatings may be, for example, a fire-resistant paint or other fire-retardant lacquers. Thus, ignition of the tank device may be inhibited in a structurally simple manner.

In a further embodiment of the invention, it is advantageously provided that the housing element comprises an underbody, said underbody comprising a double floor made of steel sheet, said double floor comprising an intermediate space. Advantageously, the intermediate space is evacuated. In a further advantageous embodiment, the intermediate space is filled with air. Thus, leakage of hydrogen from the tank device or penetration of oxygen into the tank device from the surrounding air is prevented, so as to prevent a possible fire or oxyhydrogen reaction.

In an advantageous further development, the intermediate space is filled with an insulating liquid or gel or an insulating solid. In the event of heat input, for example, the solid material would be converted into a fire-retardant liquid or gel by a phase transition, thus preventing the tank device from catching fire.

In a further embodiment of the invention, it is advantageously provided that cavities are formed in the housing element between the tank containers, the feed line, the connection line, the valves and other attachment components of the tank device, in which fire-retardant or heat-insulating materials are arranged in said cavities. Thus, the tank device catching fire can be easily prevented. In particular, such sensitive locations in the tank device, such as valves or lines, as well as other components, such as control devices, can be protected.

In an advantageous further development, it is provided that the fire-retardant or heat-insulating materials comprise rock wool, glass fiber, or other fibers, for example natural fibers with fire-retardant or heat insulating properties. Advantageously, the fire-retardant or heat-insulating materials comprise substances that can be thermally activated. Thus, the tank device catching fire can be easily prevented.

In a further embodiment of the invention, it is advantageously provided that the substances that can be thermally activated comprise granules, through which granules, for example a gas or a fire-retardant foam, can be released by means of a chemical reaction.

In one advantageous embodiment, the at least one tank container is made of steel. Thus, cost savings are achieved in a simple manner by the use of material.

In a further embodiment of the invention, it is advantageously provided that the at least one tank container comprises a shut-off valve and/or a safety valve. In this way, it can be ensured that in the event of an accident involving the entire vehicle in which one of the tank containers is damaged, the respective valve on the respective tank container can be used to at least fluidically separate it from the rest of the tank device. Furthermore, fuel can be prevented from escaping from the at least more than one tank container, which may prevent or at least reduce the risk of accidents and explosions caused by leaking fuel after an accident involving the entire vehicle.

In an advantageous further development, it is provided that the tank device is fluidically connected to a consumer system via the feed line, for example an anode area of a fuel cell assembly or a hydrogen burner system.

The tank device described herein is preferably suited for use in a fuel cell system for storing hydrogen for operating a fuel cell.

In advantageous uses, the tank device can be used in vehicles with a fuel cell drive.

In advantageous uses, the tank device can be used in vehicles with a hydrogen drive, for example in a vehicle with a hydrogen burner as a drive.

### BRIEF DESCRIPTION OF THE DRAWINGS

The invention will be described in greater detail hereinafter in reference to the drawings.

Shown are:

FIG. 1 a schematic plan view of a tank device according to the invention,

FIG. 2 a side view of a tank device consisting of tank containers according to the invention for storing a gaseous medium with a housing element,

FIG. 3 a magnified view of the housing element from FIG. 2,

FIG. 4 the schematic top plan view of the tank device according to the invention of FIG. 1 with fire-retardant or heat-insulating materials.

All of the drawings are merely schematic representations of the tank device according to the invention or its components according to exemplary embodiments of the invention. In particular, distances and size relations are not reproduced to scale in the drawings.

### DETAILED DESCRIPTION

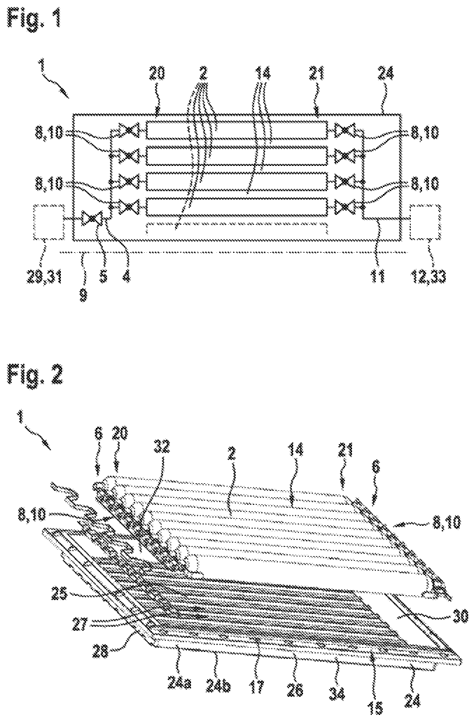

The illustration according to FIG. 1 shows a schematic top plan view of a tank device 1 according to the invention for a fuel cell system 31. The tank device 1 comprises at least two tank containers 2 for storing hydrogen, a frame-shaped housing element 24 and a feed line 4 which can be connected to the tank containers 2. The frame-shaped housing element 24 surrounds the at least two tank containers 2 and the feed line 4, wherein the at least two tank containers 2 run parallel to a longitudinal axis 9. Each of the at least two tank containers 2, which are substantially cylindrical and made of steel, comprises at least one valve 8, 10. This at least one valve 8, 10 is a shut-off valve 8 and/or a safety valve 10.

In one exemplary embodiment of the tank device 1, the at least two tank containers 2 each have the shut-off valve 8 at a first end 20, and the safety valve 10 at a second end 21, the respective ends 20, 21 being located towards the longitudinal axis 9 on the respective tank container 2. The two tank containers 2 are tubular.

Furthermore, it is shown in FIG. 1 that the shut-off valve 8 is arranged between the respective tank container 2 and the feed line 4, wherein the feed line 4 connects the respective tank containers 2 with the fuel cell system 31, in particular a fuel cell 29. In an exemplary embodiment of the fuel cell system 31, the hydrogen from the tank device 1, which is in particular under a high pressure of at least nearly 700 bar, may pass through the feed line 4 to a nozzle and/or an intake area of a jet pump of the fuel cell system 31. In addition, a valve 5 may be located in the area of the feed line 4, in particular between the shut-off valve 8 and the fuel cell system 31, in particular, an anode area of the fuel cell system 31 and/or at least indirectly with the fuel cell 29. The valve 5 may be located inside or outside the frame-shaped housing element 24.

In the area of the second end 21 of the respective tank container 2 on which the tank container 2 comprises the safety valve 10, the tank container 2 is connected to a connection line 11 via the safety valve 10. In the event of an accident and/or a fire, the connection line 11 serves to direct hydrogen from the respective tank container 2 out of the tank device 1 and thus counteract bursting of the respective tank container 2. At the end of the connection line 11 facing away from the safety valve 10 and/or the tank container 2, in particular its downstream end, there may be a discharge valve 12, via which, in the event of an accident or fire, the hydrogen can be discharged into a surrounding 33 of the vehicle, in particular into an area in which igniting hydrogen can no longer damage or harm the entire vehicle and the occupants.

In one exemplary embodiment, the safety valve 10 may be a so-called TPRD (Thermal Pressure Relief Device) valve 10, which comprises a temperature-sensitive element, in order to trigger an opening of the safety valve 10 in the event of heat input to the tank container tank 2 in an emergency. Thus, in this exemplary embodiment, the first end 20 of the respective tank container 2 is connected to the feed line 4 via the shut-off valve 8 and/or its second end 21 is connected to the connection line 11 via the safety valve 10, which is designed in particular as a melting safety valve 10.

Furthermore, in the area of the connection line 11, in particular between the safety valve 10 and the discharge valve 12, there may be a further valve.

Advantageously, steel is used for the manufacture of the tubular tank modules 2. On the one hand, steel is very robust and on the other hand very inexpensive. Advantageously, steel is very easy to process. Due to the high ductility of steel, there is an improved crash safety of vehicles with tubular tank modules.

FIG. 2 shows a side view of an embodiment of the tank device 1 according to the invention. The tank device 1 comprises a plurality of tank containers 2, which are substantially cylindrical in form. The respective ends 20, 21 of the respective tank container 2 have a conical taper 6 and thus a typical bottleneck structure.

It is shown in FIG. 2 that the frame-shaped housing element 24 in which the tank container tanks 2 are installed comprises a peripheral wall 26 and a bottom wall 25, wherein the bottom wall 25 is located at the geodetically lowest location in the tank device 1 and/or in the vehicle. The peripheral wall 26 of the frame-shaped housing element 24 comprises a front wall 28, a left wall 32, a right wall 34, and a back wall 30. Furthermore, the tank containers 2 are pre-assembled as a tank container tank module, which can consist of at least two tank containers 2 with valves 8, 10 and other components. The bottom wall 25 comprises at least one rib 27, in particular at least one stiffening rib 27, wherein the at least one rib 27 extends parallel to the longitudinal axis 9 and/or the tank containers 2 and over at least almost the entire length of the bottom wall 25, in particular in the area of an intermediate space 14 between the at least two tank containers 2. The at least one rib 27 abuts at least two tank container tanks 2, in particular at least almost orthogonally to the longitudinal axis 9, wherein in this way the stability and the crash safety of the tank device 1 according to the invention can be improved. In addition, a fixation of the individual tubes in the housing and a positioning with respect to each other can be achieved.

In addition, it is shown in FIG. 2 that the frame-shaped housing element 24 on the side of the peripheral wall 26 facing away from the bottom wall 25 comprises a circumferential shoulder 15, wherein the shoulder 15 extends parallel to the bottom wall 25 and comprises at least two bores 17. These bores 17 run at least nearly orthogonally to the plane of the bottom wall 25 and/or the plane of the shoulder 15, wherein the frame-shaped housing element 24 can be mounted to the entire vehicle by means of the bores 17 and, for example, bolt connections.

The frame-shaped housing element 24 encloses the tank container 2 and/or the tank container module with attachment parts at least almost completely and is fixedly connected to the tank containers 2 by means of a fastening element 3. In addition, the frame-shaped housing element 24 thus protects it from:

environmental factors, such as corrosive media, moisture,

mechanical loads, such as contact with the roadway or rockfall,

thermal stresses, such as fire, hot air, radiation, or convection.

The frame-shaped housing element 24 can, for example, be arranged to additionally assume a stiffening function for the body of the vehicle. Furthermore, the frame-shaped housing element 24 can be used to improve a connection of the tank device 1 to an external fueling system, as accessibility to the tank device 1 is improved. In addition, an easier integration of sensors and/or valves and/or line systems and/or further components can be ensured by means of the frame-shaped housing element 24. The housing element 24 further comprises an underbody 24a, which comprises a steel sheet. Furthermore, the housing element 24 can be thermally activated to prevent a fire or bursting of the tank device 1 in the event of possible heat effects. The underbody 24a of the housing element 24 comprises a fire-retardant coating 24b.

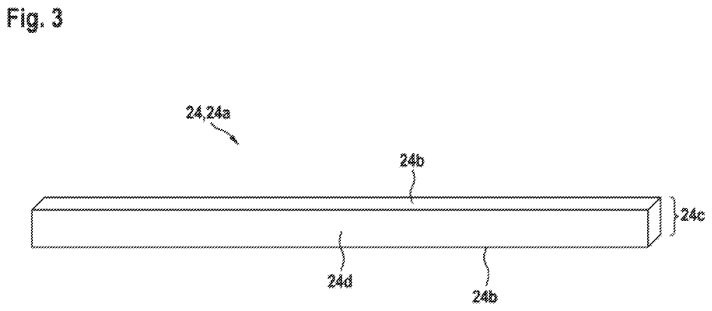

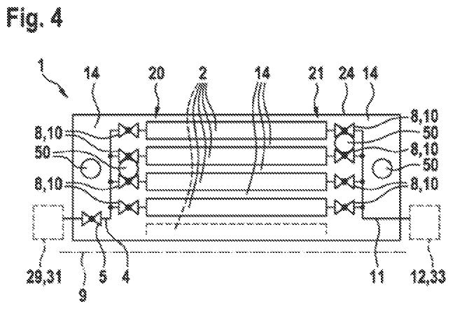

Furthermore, in a further embodiment as shown in FIG. 3, the underbody 24a of the housing element 24 comprises a double floor 24c, which has an intermediate space 24d. For example, the double floor 24c may be made of a sheet steel.

The intermediate space 24d may, for example, be evacuated or filled with air to insulate the tank device. Furthermore, in alternative embodiments, the intermediate space 24d may be filled with an insulating liquid or gel or an insulating solid.

FIG. 4 shows the exemplary embodiment of FIG. 1, a schematic top plan view of the tank device 1 according to the invention for a fuel cell system 31 with fire-retardant or heat-insulating materials 50. These are configured in the cavities 14 formed in the housing element 24 between the tank containers 2, the feed line 4, the connection line 11, the valves 8, 10, and other attachment components of the tank device 1. It is advantageous to particularly protect these areas in the event of a fire.

The fire-retardant or heat-insulating materials 50 comprise rock wool, glass fiber, or other fibers, such as natural fibers with fire-retardant or heat insulating properties.

In an alternative embodiment, the fire-retardant or heat-insulating materials 50 comprise substances that can be thermally activated comprising granules, through which, for example, a gas or a fire-retardant foam can be released by means of a chemical reaction. In the event of hydrogen escaping out of the tank containers 2, the oxygen necessary for the fire is thus displaced and an oxyhydrogen reaction or a fire is prevented.

The fire-retardant effect may still be improved if the fire-retardant substances are released over a period of time and not immediately to their full extent.

The tank device 1 for storing a gaseous medium can be used not only in fuel cell-powered vehicles, but also for, e.g., hydrogen storage in vehicles having a hydrogen burner as the drive.

1. A tank device for storing of a gaseous medium comprising at least one tank container (2) and a feed line (4) which can be connected to the at least one tank container (2), the at least one tank container (2) being fluidically connected to the feed line (4) by at least one valve (8, 10), the at least one tank container (2) is fluidically connected to a connection line (11) via at least one valve (8, 10), wherein a frame-shaped housing element (24) is arranged in the tank device (1), the housing element (24) surrounding the at least one tank container (2) and the feed line (4), wherein the housing element (24) can be thermally activated.

2. The tank device (1) according to claim 1, wherein the housing element (24) comprises an underbody (24a), the underbody (24a) comprising at least one steel sheet.

3. The tank device (1) according to claim 2, wherein the underbody (24a) comprises a fire-retardant coating (24b).

4. The tank device (1) according to claim 1 wherein the housing element (24) comprises an underbody (24a), the underbody (24a) comprising a double floor (24c) made of steel sheet, the double floor (24c) comprising an intermediate space (24d).

5. The tank device (1) according to claim 4, wherein the intermediate space (24d) is evacuated.

6. The tank device (1) according to claim 4, wherein the intermediate space (24d) is filled with air.

7. The tank device (1) according to claim 4, wherein the intermediate space (24d) is filled with an insulating liquid or gel or an insulating solid.

8. The tank device (1) according to claim 1 wherein cavities (14) are formed in the housing element (24) between the tank containers (2), the feed line (4), the connection line (11), the valves (8, 10), and other attachment components of the tank device (1), in which fire-retardant or heat-insulating materials (50) are arranged in the cavities (14).

9. The tank device (1) according to claim 8, wherein the fire-retardant or heat-insulating materials (50) comprise rockwool, glass fiber, or other fiber, such as natural fibers with fire-retardant or heat-insulating properties.

10. The tank device (1) according to claim 8, wherein the fire-retardant or heat-insulating materials (50) comprise substances that can be thermally activated.

11. The tank device (1) according to claim 10, wherein the substances that can be thermally activated comprise granules, through which granules a gas or a fire-retardant foam can be released by a chemical reaction.

12. The tank device (1) according to claim 1, wherein there are at least two tank containers (2), the at least two tank containers (2) are made of steel.

13. The tank device (1) according to claim 1, wherein the at least one tank container (2) comprises a shut-off valve (8) and/or a safety valve (10).

14. The tank device according to claim 1, wherein the tank device (1) is fluidically connected to a consumer system via the feed line (4).

15. A fuel cell assembly having a tank device (1) for storing hydrogen for operating a fuel cell according to claim 1.

16. The tank device (1) according to claim 1, wherein the gaseous medium is hydrogen.

17. The tank device (1) according to claim 14, wherein the consumer system is an anode area of a fuel cell assembly or a hydrogen burner system.
